(19) United States
(12) Patent Application Publication
(10) Pub. No.: US 2003/0210681 A1
(43) Pub. Date: Nov. 13, 2003

(54) Method and apparatus for controlling delay fluctuation absorption buffer

(75) Inventors: Yutaka Sumi, Tokyo (JP); Takeyoshi Nishina, Tokyo (JP); Koji Sugaya, Tokyo (JP); Manabu Kimyou, Hachinohe-shi (JP); Satoru Shiratori, Hachinohe-shi (JP)

Correspondence Address: OLIFF & BERRIDGE, PLC, P.O. BOX 19928, ALEXANDRIA, VA, 22320, US

(73) Assignee: TAIKO ELECTRIC WORKS, LTD., Tokyo (JP)

(21) Appl. No.: 10/428,986

(22) Filed: May 5, 2003

(30) Foreign Application Priority Data
May 13, 2002 (JP) 2002-136835
Apr. 16, 2003 (JP) 2003-111166

(51) Int. Cl. H04L 1/00

(52) U.S. Cl. 370/352

(57) ABSTRACT

Method of controlling a delay fluctuation absorption buffer and apparatus for controlling a delay fluctuation absorption buffer are able to cope with a delay fluctuation magnitude that changes at any time depending upon traffic situations of a packet transmission channel when information that should be reproduced in real-time is transmitted in the form of packets. When receiving audio data is started, received packets are started to be read out from a delay fluctuation absorption buffer after received packets of the number equal to a start accumulation packet number had been accumulated in the delay fluctuation absorption buffer. If the number of received packets accumulated in the delay fluctuation absorption buffer exceeds a maximum accumulation packet number, then received packets of a predetermined number are discarded. The start accumulation packet number and the maximum accumulation packet number are dynamically changed in response to increase and decrease of magnitude of a delay fluctuation occurred in the transmission system, whereby the delay fluctuation absorption buffer may absorb the delay fluctuation.

### BACKGROUND OF THE INVENTION

VoIP (Voice over Internet Protocol) telephone systems are now commercially available on the market for making telephone communications by the use of telephony such as the Internet or a intranet that is able to transmit audio signals over the IP (Internet Protocol) networks. This VoIP telephone system is configured in accordance with the ITU-T (International Telecommunication Union-Telecommunication standardization sector) recommendations H.323 that is the general standard for LAN (Local Area Network), for example.

In this case, an audio signal of the telecommunication is packetized at every predetermined time period and transmitted sequentially over the LAN. An RTP (Real-time Transport Protocol) is used as a protocol of a transport layer for transmitting this audio signal.

In accordance with the RTP, the transmission side transmits a packet with a packet order number (packet sequence number) and a time stamp (time information) in an RTP header. Then, the reception side in the RTP can operate in real-time by synchronizing reproductions of the audio signal based upon the packet sequence number and the time stamp.

As one of factors by which call quality is caused to be deteriorated in communication between the VoIP terminals, there may be enumerated a delay fluctuation occurred in an interval between arrival times of RTP packets received through the LAN. Various countermeasures have been worked out so far in order to solve this problem of the delay fluctuation. Generally, in order to solve the problem of the delay fluctuation, when the reception side commences to receive the audio signal, packets of a constant number are accumulated in a delay fluctuation absorption buffer to delay reproduction of the audio signal for executing absorption of the delay fluctuation.

The buffer size of the delay fluctuation absorption buffer is determined based upon a start accumulation packet number and a maximum accumulation packet number. The start accumulation packet number refers to the number of received packets that can delay the start of reproduction of the audio signal by delaying reading of packets from the delay fluctuation absorption buffer when the reception side commences to receive RTP packets.

Specifically, when the reception side begins to receive the RTP packets, packet data cannot be read out from the delay fluctuation absorption buffer until the received packets whose number is equal to the start accumulation packet number are accumulated in the delay fluctuation absorption buffer. Then, after the received packets of the start accumulation packet number had been accumulated in the delay fluctuation absorption buffer, when the next received packet arrives, the packet at the top of the received packets thus accumulated is read out from the delay fluctuation absorption buffer.

A maximum accumulation packet number refers to the maximum number of packets that can be accumulated in the delay fluctuation absorption buffer. This maximum accumulation packet number is equivalent to the maximum value of the delay of the reproduction of the audio signal. When the number of the packets accumulated in the delay fluctuation absorption buffer exceeds this maximum accumulation packet number, the packets of the number corresponding to the start accumulation packet number are left in the delay fluctuation absorption buffer and other accumulated packets are discarded from the delay fluctuation absorption buffer, whereby the delay of the reproduction of the audio signal can be controlled so as to fall within a range of the maximum accumulation packet number.

The buffer size, which may be determined by the start accumulation packet number and the maximum accumulation packet number, of the delay fluctuation absorption buffer has been so far a fixed value that is set in response to the circumstances under which the delay fluctuation absorption buffer is in use.

When the buffer size of the delay fluctuation absorption buffer is determined, it is to be desired that the start accumulated packet number should be set to a value greater than a magnitude of delay fluctuation obtained in the converged state wherein the delay fluctuation has been absorbed by the delay fluctuation absorption buffer. Moreover, it is to be desired that the maximum accumulated packet number should be set to a value greater than the maximum magnitude of the delay fluctuation. When these values are set properly, the delay fluctuation absorption buffer can absorb the delay fluctuation reliably with the result that excellent speech quality can be obtained.

However, a magnitude of the delay fluctuation occurred in response to the circumstances under which terminals are in use changes depending upon traffic situations of a packet transmission channel at anytime. For this reason, it is generally impossible to properly calculate a magnitude of the delay fluctuation in advance for properly setting the proper number of start accumulated packets and the proper number of maximum accumulated packets. Accordingly, it is frequently observed that the buffer size of the delay fluctuation absorption buffer is too small or too large as compared with a magnitude of the actual delay fluctuation.

When the buffer size of the delay fluctuation absorption buffer is smaller than the magnitude of the delay fluctuation thus occurred, since audio data of a plurality of packets accumulated in the delay fluctuation absorption buffer have thoroughly reproduced during a time for receiving packets is being delayed due to the occurrence of the delay fluctuation, a problem arises in which an audio signal is reproduced while sounds are not being reproduced.

When on the other hand the buffer size of the delay fluctuation absorption buffer is very larger than the magnitude of the delay fluctuation thus occurred, a problem arises in which the reproduction of audio signal is delayed more than the need.

While the transmission of audio data has been described so far, a similar problem arises not only when audio data is transmitted but also when data that should be reproduced in real-time is transmitted.

### SUMMARY OF THE INVENTION

In view of the aforesaid aspect, it is an object of the present invention to provide method of and apparatus for controlling a delay fluctuation absorption buffer which can cope with a magnitude of a delay fluctuation which changes at any time in response to traffic situations of a packet transmission channel.

According to an aspect of the present invention, there is provided a method of controlling a delay fluctuation absorption buffer in which packet data in which information that should be reproduced in real-time is packetized at every predetermined amount and sequentially transmitted is received through a delay fluctuation absorption buffer and in which a delay fluctuation occurred in timing at which the packet data arrives in the transmission system is controlled by the delay fluctuation absorption buffer. In the method of controlling a delay fluctuation absorption buffer in which received packets are started to be read out from the delay fluctuation absorption buffer after the received packets of the number corresponding to the start accumulation packet number when reception of audio data is started and in which received packets of a predetermined number are discarded when the number of received packets accumulated in the delay fluctuation absorption buffer exceeds the maximum accumulation packet number, this method comprises:

a start accumulation amount increase process for increasing and changing the start accumulation packet number and the maximum accumulation packet number when the delay fluctuation larger than a time length corresponding to the start accumulation packet number occurs in the received packets; and

a start accumulation amount decrease process for changing the start accumulation packet number and the maximum accumulation packet number to smaller start accumulation packet number and smaller maximum accumulation packet number when the magnitude of the delay fluctuation is stable at the value smaller than a time length corresponding to the start accumulation packet number obtained at that time.

In accordance with another aspect of the present invention there is provided an apparatus for controlling a delay fluctuation absorption buffer in which packets in which information that should be reproduced in real-time are packetized at every predetermined time period and transmitted sequentially are received through a delay fluctuation absorption buffer and in which a delay fluctuation occurred in timing at which the packets arrive in a transmission system is controlled by the delay fluctuation absorption buffer. This apparatus for controlling a delay fluctuation absorption buffer is comprised of:

read start means for starting to read received packets from said delay fluctuation absorption buffer after the received packets of the number corresponding to a start accumulation packet number had been accumulated in the delay fluctuation absorption buffer when the packets start to be received;

received packet discarding means for discarding the received packets of the predetermined number when the number of the received packets accumulated in the delay fluctuation absorption buffer exceeds a maximum accumulation packet number; and

control means for dynamically changing the start accumulation packet number and the maximum accumulation packet number in response to increase and decrease of the magnitude of the delay fluctuation occurred in the transmission system.

In the present invention having the above-mentioned arrangement, when the delay fluctuation of the magnitude larger than a time length corresponding to the start accumulation packet number occurs in the start accumulation amount increase process, the start accumulation packet number and the maximum accumulation packet number are increased and changed.

Then, when the magnitude of the delay fluctuation is stabilized at the value smaller than a time length corresponding to the start accumulation packet number thus changed after the start accumulation packet number and the maximum accumulation packet number had been increased and changed, the start accumulation packet number and the maximum accumulation packet number obtained at that time are changed to smaller values in the start accumulation amount decrease process.

Therefore, according to the present invention, since the buffer size of the delay fluctuation absorption buffer can be controlled so as to be dynamically matched with the magnitude of the delay fluctuation that changes at any time depending upon traffic situations of the packet transmission channel. Thus, according to the present invention, when packet data is audio data, for example, a problem in which audio data is reproduced while sounds are not being generated can be alleviated. Furthermore, according to the present invention, a problem in which reproduction of sounds is delayed more than need can be avoided.

### BRIEF DESCRIPTION OF THE DRAWINGS

FIG. 1 is a diagram schematically showing an example of an arrangement of a VoIP telephone system to which the present invention is applied;

FIG. 2 is a block diagram showing an example of an arrangement of a gate keeper comprising the VoIP telephone system in the example shown in FIG. 1;

FIG. 3 is a block diagram showing an example of an arrangement of a telephone terminal comprising the VoIP telephone system in the example shown in FIG. 1;

FIG. 4 is a block diagram showing an example of an arrangement of a gateway comprising the VoIP telephone system in the example shown in FIG. 1;

FIG. 5 is a diagram to which reference will be made in explaining an arrangement of a delay fluctuation absorption buffer according to an embodiment of the present invention;

FIG. 6 is a block diagram to which reference will be made in explaining an arrangement of a control apparatus for use with the delay fluctuation absorption buffer according to an embodiment of the present invention;

FIG. 7 is a flowchart to which reference will be made in explaining a part of a method of controlling a delay fluctuation absorption buffer according to an embodiment of the present invention;

FIG. 8 is a flowchart to which reference will be made in explaining a part of a method of controlling a delay fluctuation absorption buffer according to an embodiment of the present invention;

FIG. 9 is a flowchart to which reference will be made in explaining a part of a method of controlling a delay fluctuation absorption buffer according to an embodiment of the present invention;

FIG. 10 is a flowchart to which reference will be made in explaining processing for transmitting data from a delay fluctuation absorption buffer according to an embodiment of the present invention;

FIG. 11 is a diagram to which reference will be made in explaining the manner in which accumulated packets are changed and the buffer size of the delay fluctuation absorption buffer is changed according to an embodiment of the present invention;

FIG. 12 is a diagram to which reference will be made in explaining the manner in which accumulated packets are changed and the buffer size of the delay fluctuation absorption buffer is changed according to an embodiment of the present invention; and

FIG. 13 is a diagram to which reference will be made in explaining the manner in which accumulated packets are changed and the buffer size of the delay fluctuation absorption buffer is changed according to an embodiment of the present invention.

### DESCRIPTION OF THE PREFERRED EMBODIMENT

A method of controlling a delay fluctuation absorption buffer according to the present invention will be described with reference to the drawings. In this embodiment, the present invention is applied to transmission of audio packets in the VoIP telephone system, by way of example.

FIG. 1 of the accompanying drawings is a block diagram showing an outline of the entire arrangement of the VoIP telephone system according to an embodiment of the present invention.

As shown in FIG. 1, the VoIP telephone system according to this embodiment consists of a gate keeper 1, a plurality of telephone terminals (terminals conforming to the ITU-T recommendations H.323) 2, a LAN 3 and a VoIP gateway 4.

The telephone terminal 2 functions as a computer as well and includes a handset 21. A plurality of telephone terminals 2 are connected to the LAN 3 that comprises the IP network, respectively, and the gate keeper 1 also is connected to the LAN 3. A plurality of telephone terminals 2 are therefore connected to the gate keeper 1 through the LAN 3.

The VoIP gateway 4 is connected to a telephone network 5 through a telephone line 6 that can afford a plurality of telephone lines and is also connected to the LAN 3. The telephone line 6 contains an ISDN (Integrated Services Digital Network) line, a dedicated line and so forth. This gateway 4 plays a part of relay administration equipment that has the function of connecting the telephone network 5 and the IP network. More specifically, the gateway 4 converts a continuous sound signal into an IP sound packet and vice versa and interchanges IP sound packets between it and the gate keeper 1. Further, the gateway 4 converts telephone numbers into IP addresses and vice versa.

In this case, the LAN 3 has an IP network configuration that conforms to the standards of the ITU-T recommendation H.323.

The gate keeper 1 is in charge of a main administration function in the system configuration of the ITU-T recommendation H.323 and is comprised of a personal computer, for example. A plurality of telephone terminals 2 is registered on the gate keeper 1 when they are connected to the LAN 3.

The gate keeper 1 controls interchange of the gateway 4 and a plurality of telephone terminals 2 within the telephone system, assigns bandwidths and matches telephone numbers with IP addresses. Then, the gate keeper 1 plays a part of interchange administration equipment having a function to control telephone communications made by a plurality of telephone terminals 2 registered on the gate keeper 1 over a plurality of telephone lines 6.

[Example of Arrangment of Hardware of Gate Keeper 1]

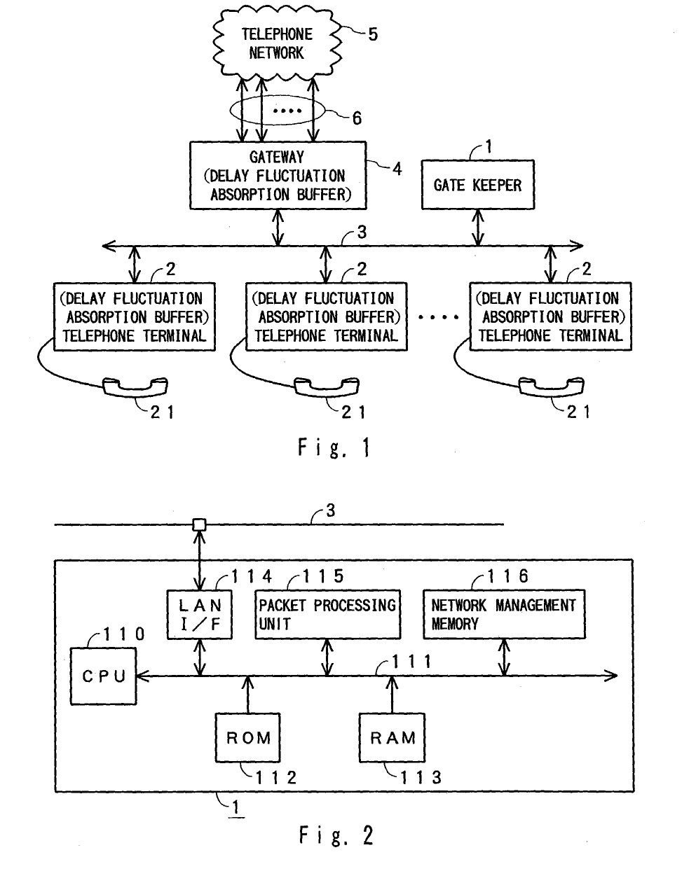

FIG. 2 is a schematic block diagram showing an example of an arrangement of hardware of the gate keeper 1 in the telephone system according to this embodiment. The gate keeper 1 according to this embodiment is composed of a personal computer, for example. As shown in FIG. 2, a ROM (read-only memory) 112, a RAM (random-access memory) 113, a LAN interface 114, a packet processing unit 115 and a network administration memory 116 are connected through a system bus 111 to a CPU (central processing unit) 110. The ROM 112 has stored therein processing programs, to be executed by the gate keeper 1, such as processing programs for converting telephone number information into IP addresses and vice versa.

The RAM 113 is used as a work area required when programs of mainly the ROM 112 are executed under control of the CPU 110.

The LAN interface 114 has a function to fetch packetized data transmitted through the LAN 3 and also has a function to transmit packetized data to the LAN 3.

The packet processing unit 115 has a function to decompose a received packet in order to decode control data when a packet fetched through the LAN interface 114 is control data and also has a function to generate packetized data of transmitted control data.

Audio data packets are generally interchanged between the gateway 4 and the telephone terminals 2, bypassing the gate keeper 1.

However, packets of audio data are not always transmitted bypassing the gate keeper 1 but they may be transferred through the gate keeper 1. In that case, the gate keeper 1 transfer packets received from the gateway 4 to the telephone terminal 2. Moreover, the gate keeper 1 transfers packets received from the telephone terminal 2 to the gateway 4 or other telephone terminal 2.

The packet processing unit 115 includes a buffer memory (not shown) to decompose/generate packetized data and to temporarily store therein packetized data for executing the transfer processing.

The network management memory 116 stores therein information of the gateway 4 and registration information of a plurality of telephone terminals 2, their IP addresses and information such as correspondence information of IP addresses of the telephone terminals 2 and telephone numbers. The CPU 110 determines destination IP addresses of packets and judges IP addresses of transmission side by using those information.

[Example of Arrangement of Hardware of Telephone Terminal 2]

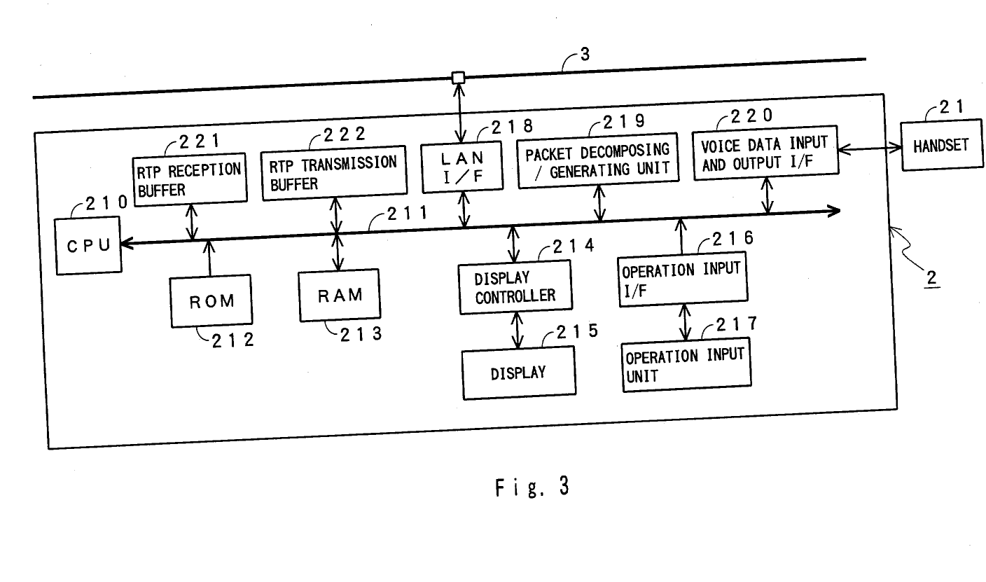

FIG. 3 is a schematic block diagram showing an example of an arrangement of hardware of the telephone terminal 2 in the telephone system according to this embodiment. As shown in FIG. 3, the telephone terminal 2 according to this embodiment includes a terminal body 200 and a handset 21. Although not shown, the handset 21 includes a microphone comprising a telephone transmitter, a transmission amplifier, a speaker comprising a telephone receiver and a reception amplifier.

The terminal body 200 consists of a computer to which there are connected a ROM (read-only memory) 212, a RAM (random-access memory) 213, a display controller 214, an operation input interface (“interface” will be abbreviated as an “I/F” in this sheet of drawing and the following drawings for simplicity) 216, a LAN interface 218, a packet decomposing/generating unit 219, a audio data input and output interface 220 and an RTP reception buffer 221 and an RTP transmission buffer 222, both of which comprise a delay fluctuation absorption buffer, through a system bus 211.

A display 215 is connected to the display controller 214 and the display 215 displays various data and information on its screen under control of the CPU 210.

The operation input interface 216 has connected thereto an operation input unit 217 that includes ten-keys, cursor keys and other operation keys. The CPU 210 is able to recognize which input key the user operates through the input interface 216 from the operation input unit 217 and is able to execute processing corresponding to key input operations in accordance with programs stored in the ROM 212.

The ROM 212 has stored therein suitable programs such as programs for executing processing sequences to register the telephone terminal 2 on the gate keeper 1 and programs for dynamically controlling the buffer size of the RTP reception buffer 221 in response to the delay fluctuation occurred on the LAN 3 in actual practice.

The RAM 213 is used as a work area required when the CPU 210 execute programs of mainly the ROM 212.

The LAN interface 218 has a function to fetch and sequentially transfer packetized data transmitted through the LAN 3 to the RTP reception buffer 221 and a function to sequentially transfer transmission packets of audio data stored in the RTP transmission buffer 222 to the LAN 3 while confirming space areas of the LAN 3.

The packet decomposing/generating unit 219 has a function to decompose packetized data, read out and transferred from the RTP reception buffer 221, to provide control data and audio data and a function to generate packetized data of packetized transmitted control data and packetized audio data of every predetermined amount and to transfer these packetized data to the RTP transmission buffer 222. This packet decomposing/generating unit 219 includes a buffer memory for decomposing and generating packetized data, although not shown.

While the packet decomposing function and the packet generating function of this packet decomposing/generating unit 219 are composed of a DSP (digital signal processor), they may be realized in the form of software by the CPU 210 and the ROM 212.

The audio data input and output interface 220 has a function to convert packetized audio data into an analog audio signal to thereby supply the resultant analog audio signal to the handset 21 and also has a function to convert the analog audio signal, inputted from the handset 21, into a digital signal to thereby fetch the resultant digital signal.

[Example of Arrangement of Hardware of Gateway 4]

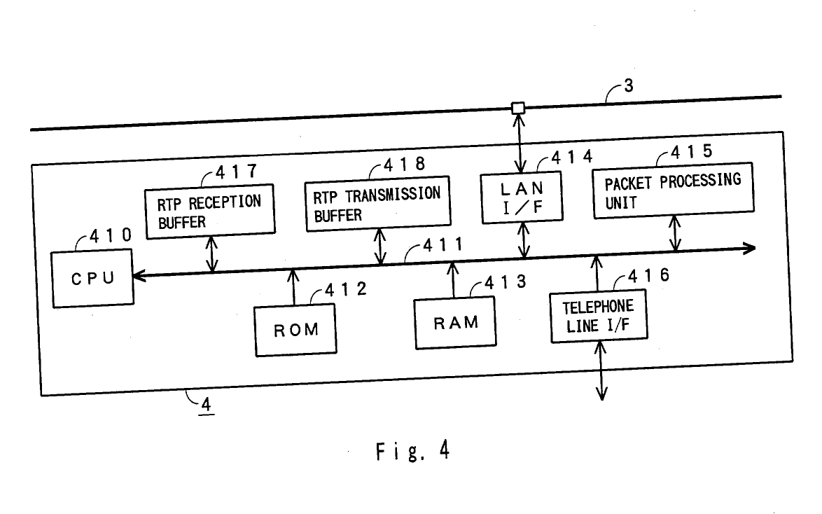

FIG. 4 is a block diagram showing an example of an arrangement of hardware of the gateway 4 in the telephone system according to this embodiment. As shown in FIG. 4, the gateway 4 according to this embodiment is composed of a personal computer, for example, in which a ROM 412, a RAM 413, a LAN interface 414, a packet processing unit 415 and an RTP reception buffer 417 and an RTP transmission buffer 418, both of which constitute a delay fluctuation absorption buffer, are connected to a CPU 410 through a system bus 411.

While one RTP reception buffer 417 and one RTP transmission buffer 418 are shown in FIG. 4, they are provided for each telephone line of a plurality of telephone lines 6, in actual practice.

The ROM 412 has stored therein suitable programs such as a program for receiving audio packet data from the telephone terminal 2 through the RTP reception buffer 417 and converting the same into data that should be sent to the telephone network 5 through the telephone line 6, a program for converting data obtained from the telephone network 5 into packetized data that should be transmitted through the LAN 3 to the telephone terminal 2 and a program for dynamically controlling the buffer size of the RTP reception buffer 417 comprising the delay fluctuation absorption buffer in response to the delay fluctuation actually occurred on the LAN 3.

The RAM 413 is used as a work area required while a program stored in the ROM 412 is executed by the CPU 410.

The LAN interface 414 has a function to fetch packetized data transmitted thereto through the LAN 3 and a function to send packetized data to the LAN 3.

The packet processing unit 415 has a function to decompose packets fetched thereto through the LAN interface 414 and to convert the decomposed data into data that should be transmitted through the line interface 416 to the telephone network 5 and a function to packetize data received through the line interface 416 from the telephone network 5 into packetized data and to send packetized data through the LAN interface 414 to the LAN 3.

[Description of Method of Controlling Delay Fluctuation Absorption Buffer]

A method of controlling a delay fluctuation absorption buffer according to this embodiment will be described below.

A method of controlling a delay fluctuation absorption buffer according to this embodiment is applied to controlling of both of the RTP reception buffer 221 of the telephone terminal 2 and the RTP reception buffer 417 of the gateway 4. In accordance with this embodiment, the buffer size of the RTP reception buffer 221 or 417 serving as the delay fluctuation absorption buffer is dynamically changed in response to a magnitude of a delay fluctuation occurred in the LAN 3 in actual practice.

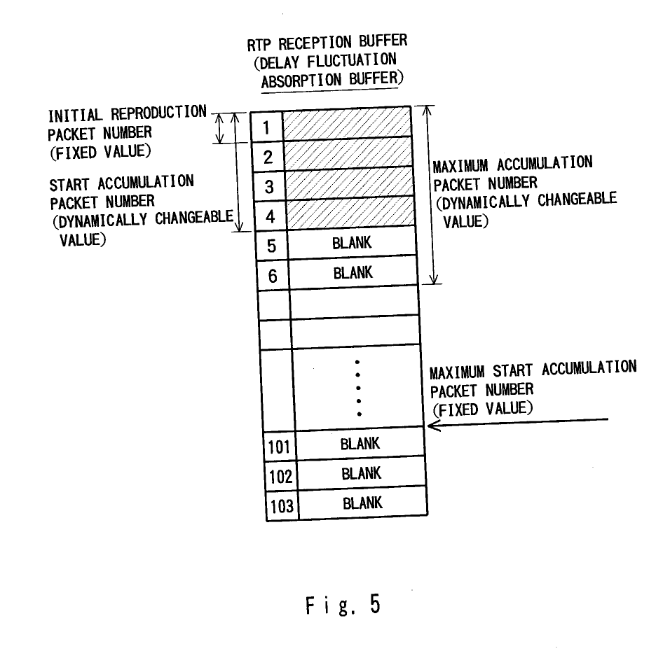

Before describing the method of controlling the buffer size of the delay fluctuation absorption buffer according to this embodiment, let us describe definitions of parameters that are used to determine the buffer size of the delay fluctuation absorption buffer with reference to FIG. 5. FIG. 5 is a schematic representation useful for explaining mainly elements that are used to determine the buffer size of the RTP reception buffer 221 or 417 serving as the delay fluctuation absorption buffer.

An “initial reproduction packet number” gives a definition of the number of packets that are read out from the RTP reception buffer. This initial reproduction packet number is the fixed value and in this embodiment, the initial reproduction packet number is set to be equal to “1”.

A “start accumulation packet number” gives a definition of the number of received packets that are used to delay the start of audio reproduction by delaying reading of packets from the RTP reception buffer when the telephone system commences to receive packets. Although the start accumulation packet number has been so far the fixed value as mentioned before, in this embodiment, the start accumulation packet number may change dynamically in response to the magnitude of the delay fluctuation occurred in the LAN 3 as will be described later on. In the examples which will follow, the initial value of the start accumulation packet number is set to be equal to “4”.

Next, a “maximum accumulation packet number” gives a definition of the maximum number of packets that can be accumulated in the RTP reception buffer serving as the delay fluctuation absorption buffer. When packets whose number is greater than this maximum accumulation packet number are accumulated in the RTP reception buffer, as mentioned before, packets whose number corresponds to the number of the start accumulation packet number are left within the RTP reception buffer and other accumulated packets are discarded from the RTP reception buffer. The number of packets that should be discarded at that time is referred to as “overflow buffer discard packet number”. In this embodiment, the overflow buffer discard packet number is set to be equal to “2”.

This maximum accumulation packet number may be defined by the following equation given as:

maximum accumulation packet number=start accumulation packet number+overflow buffer discard packet number

This maximum accumulation packet number corresponds to the maximum value of delay of audio reproduction. In this embodiment, as is clear from the above-mentioned equation of definition, the start accumulation packet number is a dynamically-changeable value and hence the maximum accumulation packet number also is the dynamically-changeable value.

Next, the “maximum start accumulation packet number” is the maximum value (upper limit) of the start accumulation packet number that is the dynamically-changeable value and is set to a fixed value.

The RTP reception buffer includes memory cells whose number is greater than the maximum start accumulation packet number as shown in FIG. 5. In this specification, the accumulation memory portion storing one packet will be referred to as a “cell”. Then, the RTP reception buffer has a ring-like buffer arrangement in which the last memory cell returns to the first memory cell from a memory access standpoint.

The packet position (memory cell) of packets read out from the RTP reception buffer is designated by a reference index. When packets are not accumulated in the memory cells designated by the reference index or when the packets of the start accumulation packet number are not accumulated in the RTP reception buffer, the packets are not read out from the RTP reception buffer so that audio signal is being reproduced while sounds are not being generated. At that time, the reference index is not incremented.

Then, when the packets of the start accumulation packet number are accumulated in the RTP reception buffer and the packets of the cells of the reference index are read out from the RTP reception buffer, the reference index is incremented.

The CPU 210 or the CPU 410 holds and manages the sequence numbers of the packets accumulated in each memory cell of the RTP reception buffer 221 or 417. The sequence number is contained in the RTP header of the packet. When the telephone system receives the packet, the telephone system obtains the sequence number by analyzing the RTP header.

Then, a “retrieval start index” is defined as follows:

Retrieval start index=reference index+initial reproduction packet number

When the telephone system receives a packet, the CPU 210 or the CPU 410 extracts a sequence number from the RTP header of the received packet and detects the sequence number. In the RTP reception buffer 221 or 417, the CPU 210 or the CPU 410 retrieves the sequence number of the packet stored in each memory cell following the retrieval index from the memory cell of the retrieval start index and determines the memory cell for storing received packets. Specifically, the CPU 210 or the CPU 410 determines the memory cell in which the sequence number of the received packet may follow the last sequence number of the packet stored in the RTP reception buffer as the memory cell for storing the received packet in the RTP reception buffer 221 or 417.

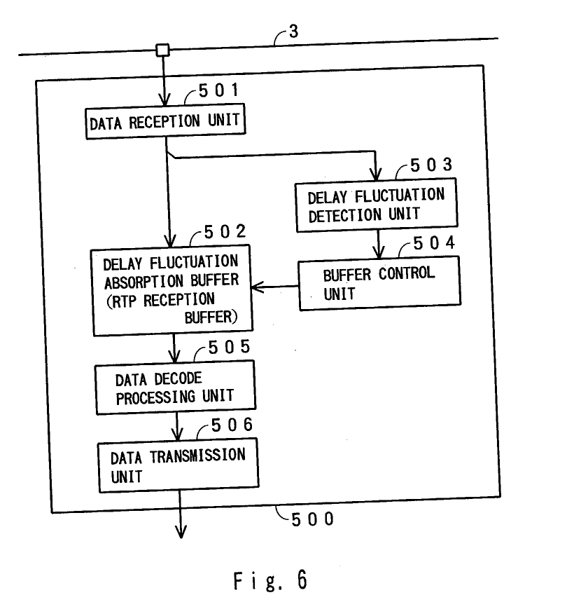

FIG. 6 is a functional block diagram of a delay fluctuation absorption buffer control apparatus 500. This delay fluctuation absorption buffer control apparatus 500 may be applied to both of the telephone terminal 2 and the gateway 4. The delay fluctuation absorption buffer control apparatus 500 corresponds to the apparatus which is obtained by extracting control portions of the RTP reception buffers 221, 417 serving as the delay fluctuation absorption buffer from the hardware of the terminal body 200 of the telephone terminal 2 shown in FIG. 3 and the hardware of the gateway 4 shown in FIG. 4.

The RTP packet transmitted to the delay fluctuation absorption buffer control apparatus 500 through the LAN 3 is received at a data reception unit 501 (corresponds to the LAN interfaces 218, 414) and accumulated in a delay fluctuation absorption buffer 502 (corresponds to the RTP reception buffer 221 or 417). The RTP packet received at the data reception unit 501 is supplied to a delay fluctuation detection unit 503 in which a magnitude of a delay fluctuation (the unit is a amount) with respect to the RTP packet occurred in the LAN 3 is detected.

The delay fluctuation detection unit 503 is able to calculate a magnitude of the delay fluctuation based upon a difference between arrival times of two received RTP packets sequentially received and a difference between time stamps contained in the RTP headers of the packets each time the packet is received.

Specifically, Tᵢ assumes a time stamp of a packet Sᵢ whose sequence number is i, Aᵢ assumes an arrival time of the packet Sᵢ and Dᵢ assumes a magnitude of the delay fluctuation obtained when the packet Sᵢ is received. Then, the delay fluctuation magnitude Dᵢ is calculated by the following equation

D₁=(A₁−Aᵢ₋₁)−(Tᵢ−Tᵢ₋₁) (1)

The delay fluctuation magnitude Dᵢ detected at the delay fluctuation detection unit 503 is supplied to a buffer control unit 504. As will be described later on, the buffer control unit 504 controls the buffer size of the RTP reception buffer based upon the delay fluctuation magnitude Dᵢ detected at the delay fluctuation detection unit 503. Then, while executing the delay fluctuation absorption processing, the buffer control unit 504 reads out the received packet from the delay fluctuation absorption buffer 502 and supplies the received packet thus read to a data decode processing unit 505.

The data decode processing unit 505 decomposes the received packet to decode audio data. Then, the data decode processing unit 505 supplies the audio data thus decoded to a data transmission unit 506.

The data transmission unit 506 converts the audio data into an analog audio signal and supplies the resultant analog audio signal to the handset 21 in the case of the telephone terminal 2. In the case of the gateway 4, the data transmission unit 506 sends audio data through an idle network line to the telephone network 5.

The CPU 210 or 410 executes the operations of the delay fluctuation detection unit 503 and the buffer control unit 504. The data decode processing unit 505 is composed of a DSP (Digital Signal Processor). The data transmission unit 506 is composed of the audio data input and output interface 220 or the line interface 416.

[Control Operation of Start Accumulation Amount in Buffer Control Unit 504]

In this embodiment, the start accumulation amount (corresponds to the start accumulation packet number) of the RTP reception buffer is dynamically controlled in response to the magnitude of the delay fluctuation occurred on the LAN 3. The dynamic control of the start accumulation amount consists of increase control of the start accumulation amount and decrease control of the start accumulation amount. In this specification, “amount” in the accumulation amount and the like refers to a value obtained at the unit of time, and “packet number” in the accumulation packet number or the like refers to a value obtained by dividing a time shown as the “amount” with a time per packet. According to this embodiment, while the transmission side packetizes the audio signal at every predetermined time interval and transmits packetized audio data to the LAN 3. The predetermined time interval is equal to the time per packet.

[Increase Procedure of Start Accumulation Amount]

In accordance with this embodiment, when the delay fluctuation whose magnitude is larger than the start accumulation amount is generated on the LAN 3 either successively or periodically, the buffer control unit 504 re-accumulates received packets by increasing the start accumulation amount of the delay fluctuation absorption buffer (RTP reception buffer) 502. The increase procedure will be described below.

(1) Calculation of Increase Target Accumulation Amount:

The delay fluctuation detection unit 503 detects a magnitude of the delay fluctuation each time the telephone system receives the packet. The buffer control unit 504 calculates the increase target accumulation amount from the increase and the decrease of the detected delay fluctuation magnitude. The increase target accumulation amount is a target value required when the buffer control unit 504 increases the start accumulation amount.

Assuming now that IBᵢ represents the increase target accumulation amount, IB₀ represents the initial value of the increase target accumulation amount IBᵢ and that Dᵢ represents the magnitude of the delay fluctuation, then the buffer control unit 504 calculates the increase target accumulation amount IBᵢ as follows:

The suffix i is equivalent to the sequence number of the packet.

IB₀=start accumulation amount

IBᵢ=IBᵢ₋₁+fa(Dᵢ, IBiᵢ₋₁)/CI (2)

Where when an inequality of Dᵢ>IBᵢ₋₁ is satisfied

fa(Dᵢ, IBᵢ₋₁)=Dᵢ−IBᵢ₋₁

when an inequality of Dᵢ<IBᵢ₋₁ is satisfied,

fa(Dᵢ, IBᵢ₋₁)=0 (3)

CI represents the convergence velocity constant and an inequality of CI≧1 is satisfied. By this convergence velocity constant CI, influences of delay fluctuations occurred locally can be suppressed and the magnitude of the delay fluctuation occurred successively can be obtained.

(2) Updating of Start Accumulation Amount

When the RTP reception buffer 502 is emptied by the delay fluctuation, the buffer control unit 504 sets an equality of start accumulation amount=increase target accumulation amount. That is the buffer control unit 504 increases the accumulation amount by replacing the start accumulation amount with the increase target accumulation amount. Then, the buffer control unit 504 stops reading of packets from the RTP reception buffer and re-accumulates received packets in the RTP reception buffer until the start accumulation amount reaches the updated start accumulation amount. When an inequality of increase target accumulation amount>maximum start accumulation amount is satisfied, an equality of increase target accumulation amount=maximum start accumulation amount is satisfied, whereby the maximum value of the start accumulation amount is limited.

As described above, according to this embodiment, if a duration of time period in which the delay fluctuation is generated successively or periodically is sufficiently long, then since the shortage amount of the accumulation amount for the delay fluctuation is accumulated in the increase target accumulation amount, the increase target accumulation amount converges to a value corresponding to a proper delay fluctuation magnitude (IBᵢ>Dᵢ). Accordingly, the delay fluctuation can be absorbed in response to the magnitude of occurred delay fluctuation by replacing the start accumulation amount with the increase target accumulation amount thus converged.

[Decrease Procedure of Start Accumulation Amount]

Next, the decrease control procedure of the start accumulation amount will be described.

It is frequently observed that the delay fluctuation is converged to a smaller value after the start accumulation amount has increased as described above. If the start accumulation amount is held at the increased value after the magnitude of the delay fluctuation has converged to the small value, then a problem arises in which delay (speech delay) will increase.

According to this embodiment, when the magnitude of the delay fluctuation is stable at the value smaller than the start accumulation amount obtained at that time, the start accumulation amount may decrease to a proper value in order to decrease the speech delay. In this embodiment, it is determined by the following procedure whether or not a magnitude of the delay fluctuation is stable, and a proper start accumulation amount is calculated.

(1) Calculation of Decrease Target Accumulation Amount:

The delay fluctuation detection unit 503 detects a magnitude of the delay fluctuation each time the telephone system receives a packet. The buffer control unit 504 calculates a decrease target accumulation amount, which is used to calculate a target value required when the start accumulation amount is decreased, on the basis of the increase and decrease of the detected delay fluctuation amount. Specifically, assuming now that DBᵢ represents the decrease target accumulation amount, DB₀ represents the initial value of the decrease target accumulation amount, Dᵢ represents the magnitude of the delay fluctuation, and that IBᵢ represents the increase target accumulation amount, then the buffer control unit 504 calculates the decrease target accumulation amount DBᵢ as follows:

DB₀=0

When an inequality of Dᵢ>IBᵢ₋₁ is satisfied

DBᵢ=0

When an inequality of Dᵢ<IBᵢ₋₁ is satisfied

DBᵢ=DBᵢ₋₁+fb(Dᵢ, DBᵢ₋₁)/CD (4)

Where an inequality of Dᵢ>DBᵢ₋₁ is satisfied

fb(Dᵢ, DBᵢ₋₁)=Dᵢ−DBᵢ₋₁

When an inequality of Dᵢ≦DBᵢ₋₁ is satisfied

fb(Dᵢ, DBᵢ₋₁)=0 (5)

CD represents the convergence velocity constant and an inequality of CD≧1 is satisfied. The reason that the increase target accumulation amount IBᵢ is used to judge updating of the decrease target accumulation amount DBᵢ in the above-mentioned equation (4) is to synchronize the equation (4) with the aforementioned equations (2) and (3).

(2) How to Judge Whether the Delay Fluctuation is Stable:

It is judged by the buffer control unit 504 whether or not the delay fluctuation became stable based upon the duration of the time period (corresponding to the number at which packets are received) in which the decrease target accumulation amount does not change. It is determined by the buffer control unit 504 based upon a convergence period count value CNT whether or not the delay fluctuation became stable. The convergence period count value CNT is updated by the following procedure:

When an inequality of Dᵢ>DBᵢ₋₁ is satisfied

CNT=0

When an inequality of Dᵢ<DBᵢ₋₁ is satisfied

CNTᵢ=CNTᵢ₋₁+1 (6)

Then, it is checked by the buffer control unit 504 whether or not the convergence period count value CNT became larger than the previously-determined convergence period constant CNT-th that is recognized as the convergence count value where the delay fluctuation is stabilized. If the convergence count value CNT becomes larger than the convergence period constant CNT-th, then it is determined by the buffer control unit 504 that the delay fluctuation has been stabilized.

The convergence period constant CNT-th may be either a fixed value or a value that can be changed depending upon the size of the received packet.

(3) Buffer Updating Judgment and Buffer Updating Processing:

If the convergence period count value CNT becomes larger than the convergence period constant CNT-th so that it is determined that the delay fluctuation has been stabilized, then it is determined by the buffer control unit 504 whether or not the buffer size of the RTP reception buffer 502 should be changed. The buffer control unit 504 determines by determining whether or not a difference between the start accumulation amount and the decrease target accumulation amount whether or not the buffer size of the RTP reception buffer 502 should be changed. The minimum decrease amount is set to a time period of one packet, for example.

If it is determined by the buffer control unit 504 based on the judged result of the buffer updating that a difference between the start accumulation amount and the decrease target accumulation amount is smaller than the previously-determined minimum decrease amount, then it is determined by the buffer control unit 504 that the buffer size of the RTP reception buffer 502 need not be decreased. Therefore, the buffer control unit 504 resets the convergence period count value CNT and the decrease target accumulation amount to zero.

If it is determined by the buffer control unit 504 based upon the judged result of the buffer updating that the difference between the start accumulation amount and the decrease target accumulation amount is larger than the previously-determined minimum decrease amount, then the buffer control unit 504 executes the buffer updating processing to satisfy the equality of start accumulation amount=decrease target accumulation amount and decreases the start accumulation amount up to the decrease target accumulation amount. However, the start accumulation amount that can be decreased by one buffer updating procedure is limited by the maximum decrease amount that was previously set as a parameter. Then, the buffer control unit 504 resets the convergence period count value CNT and the decrease target accumulation amount to zero and discards the packets from the decreased buffer.

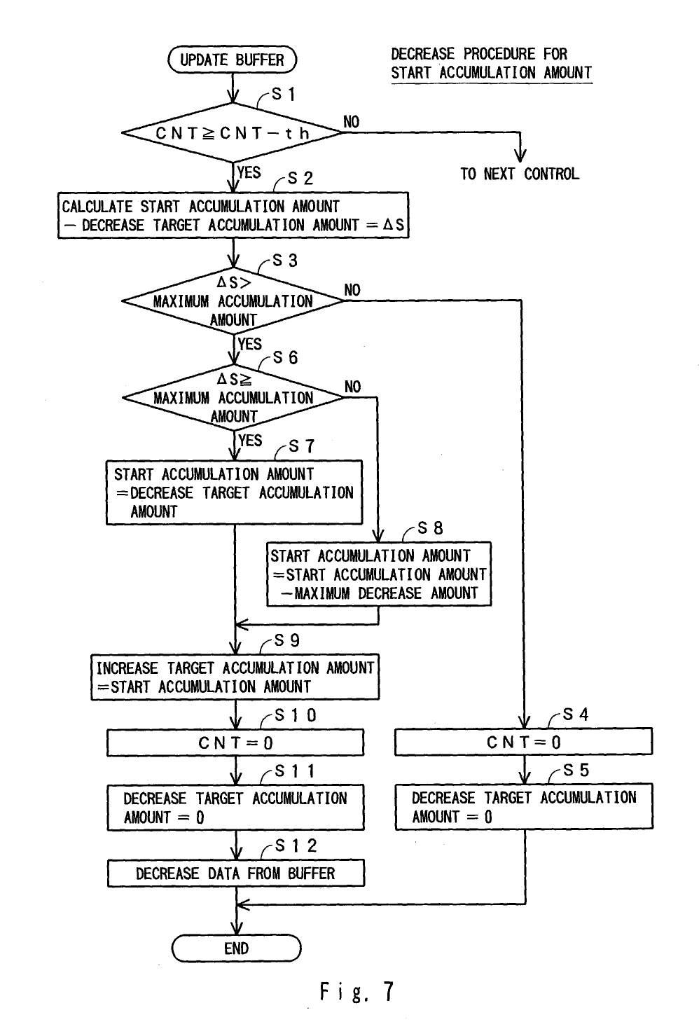

The above-mentioned buffer updating judgment routine and buffer updating processing routine will be described more in detail with reference to a flowchart of FIG. 7. The processing shown in the flowchart of FIG. 7 is executed by the buffer control unit 504 each time the telephone system receives packets. As mentioned hereinbefore, the processing in the buffer control unit 504 is executed by the CPU 210 in the case of the telephone terminal 2 and is also executed by the CPU 410 in the case of the gateway 4.

First, referring to FIG. 7, it is determined by the buffer control unit 504 at a decision step S1 whether or not the convergence period count value CNT becomes larger than the convergence period constant CNT-th so that the delay fluctuation is stabilized. If the delay fluctuation is not yet stabilized as represented by a NO at the decision step S1, then the buffer control unit 504 goes to other processing step from this routine.

If on the other hand the delay fluctuation is stabilized as represented by a YES at the decision step S1, then control goes to a step S2, whereat the buffer control unit 504 calculates a subtracted result ΔS by subtracting the decrease target accumulation amount from the start accumulation amount obtained at that time. Then, it is determined by the buffer control unit 504 at a next decision step S3 whether or not the subtracted result As is larger than the previously-set minimum decrease amount.

If the subtracted result As is smaller than the previously-set minimum decrease amount as represented by a NO at the decision step S3, then control goes to a step S4, whereat the buffer control unit 504 resets the convergence period count value CNT to “zero”. Then, the buffer control unit 504 resets the decrease target accumulation amount to “zero” at a next step S5.

If on the other hand the subtracted result ΔS is larger than the previously-set minimum decrease amount as represented by a YES at the decision step S3, then control goes to a next decision step S6, whereat it is determined by the buffer control unit 504 whether or not the subtracted result As is less than the previously-set maximum decrease amount.

If the subtracted result Δs is less than the previously-set maximum decrease amount as represented by a YES at the decision step S6, then control goes to a step S7, whereat the buffer control unit 504 sets an equality of start accumulation amount=decrease target accumulation amount and decreases the start accumulation amount. If on the other hand the subtracted result AS is larger than the previously-set maximum decrease amount as represented by a YES at the decision step S6, then control goes to a step S8, whereat the buffer control unit 504 sets an equality of start accumulation amount=start accumulation amount obtained at that time−maximum decrease amount. That is the buffer control unit 504 decreases the start accumulation amount by the maximum decrease amount.

Having executed the steps S7 and S8, the buffer control unit 504 executes a step S9, whereat the buffer control unit 504 replaces the increase target accumulation amount with the updated start accumulation amount. In other words, from this time, the initial value of the increase target accumulation amount becomes the updated start accumulation amount.

Then, control goes to a step S10, whereat the buffer control unit 504 resets the convergence period count value CNT to “zero” and also resets the decrease target accumulation amount to “zero” at a next step S11. Further, control goes to a step S12, whereat the buffer control unit 504 discards packet data, overflowed when the start accumulation amount was decreased, from the RTP reception buffer. The number of packets that had been discarded when the start accumulation amount was decreased is not a fixed value like the number of discarded overflowed buffers that should be discarded when the number of packets exceeds the maximum accumulation packet number and packets are overflowed and is a variable value that can be changed dynamically.

[Processing Routine for Controlling Delay Fluctuation Absorption Buffer]

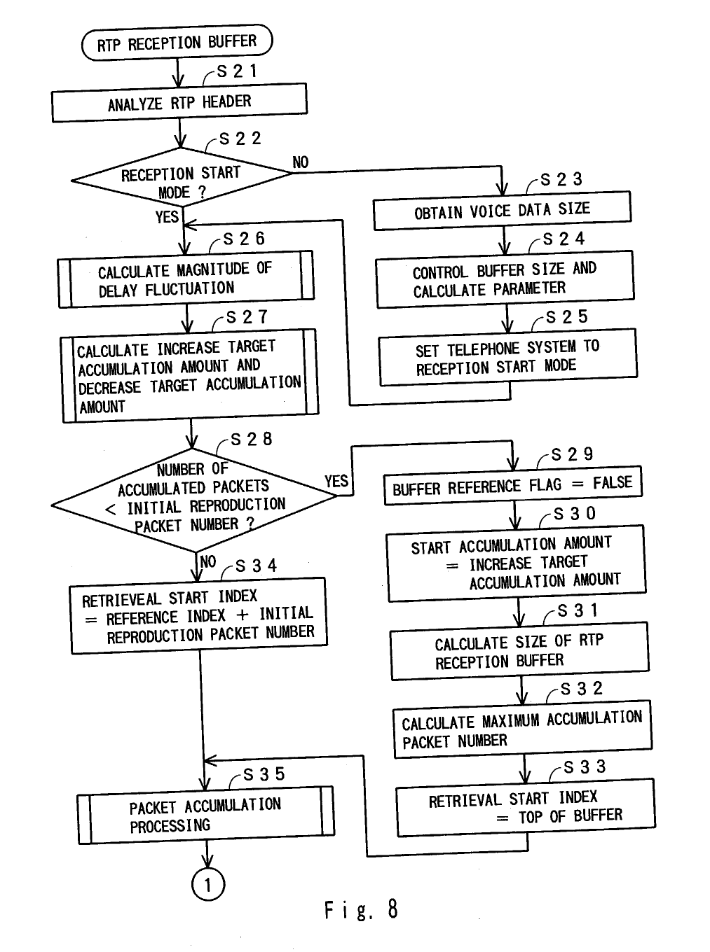

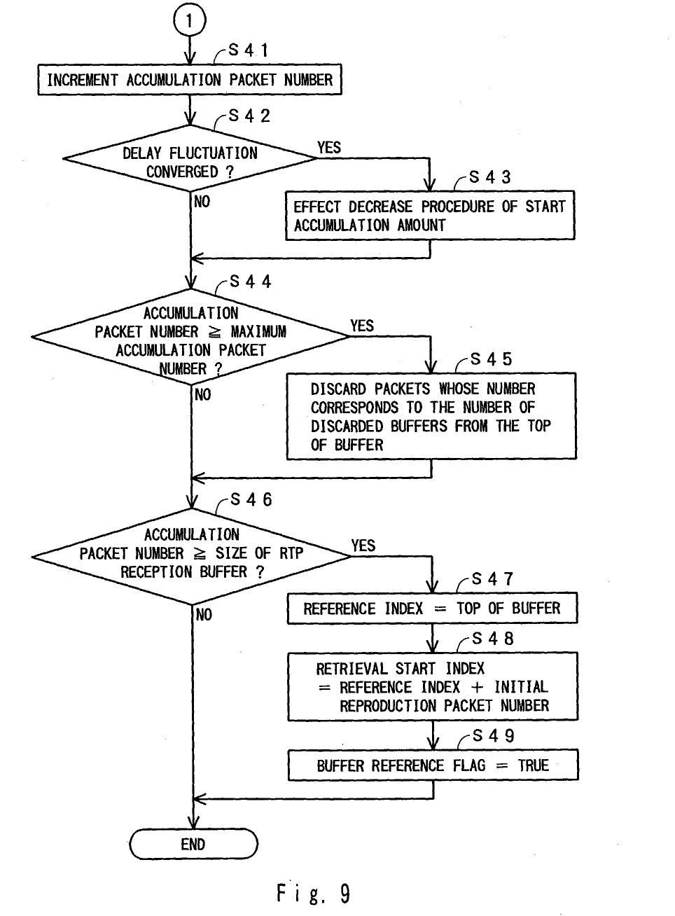

Next, the manner for controlling the buffer size of the delay fluctuation absorption buffer and the read processing operations will be described below with reference to flowcharts of FIGS. 8 and 9.

Referring to FIG. 8, following the reception of the RTP packet, interrupt occurs in the CPU 210 at the telephone terminal 2 or interrupt occurs in the CPU 410 at the gateway 4 and hence processing routines shown in the flowcharts of FIGS. 8 and 9 are started. The following steps will be executed by the CPU 210 or the CPU 410. In the descriptions which will follow, the CPU 210 or the CPU 410 will be referred to as a “CPU” for simplicity.

As shown in FIG. 8, following the reception of the RTP packet, control goes to a step S21, whereat the CPU analyzes the RTP header of the received packet. Then, control goes to the next decision step S22, whereat it is determined by the CPU whether or not the telephone terminal 2 or the gateway 4 has already commenced to receive packets.

If the telephone terminal 2 or the gateway 4 is not yet placed in the packet reception start mode and the received packet is the first packet of the start of the reception as represented by a NO at the decision step S22, then control goes to a step S23. In the step S23, the CPU recognizes the packet size, i.e. the audio data size on the basis of previously-determined parameter.

Specifically, according to this embodiment, while the transmission side packetizes the audio signal at every predetermined time interval and transmits packetized audio data to the LAN 3. A duration of the predetermined time interval (size of audio data) required to packetize the audio signal can be selected from several sizes such as 10 milliseconds, 20 milliseconds and 30 milliseconds. Then, information (parameter) indicative of the size of the packetized audio signal is determined by exchange of control signals before audio data is transmitted and received and the CPU can recognize the audio data size based upon such information (parameter).

After the CPU has recognized the audio data size at the step S23, control goes to a step S24, whereat the CPU calculates buffer size control parameters such as the initial reproduction packet number, the initial value of the start accumulation packet number, the overflow buffer discard packet number and the maximum start accumulation packet number. In this embodiment, the initial value of the start accumulation amount, the overflow buffer discard packet number and the maximum start accumulation amount are determined at the unit of time and the parameters are converted from the audio data size serving as the duration of each packet into numbers of the packet.

For example, when the initial value of the start accumulation amount is set to 30 milliseconds, the buffer discard amount is set to 20 milliseconds and the maximum start accumulation amount is 1000 milliseconds and the audio data size is set to 10 milliseconds/packet, the initial value of the start accumulation packet number becomes “3”, the overflow buffer discard packet number becomes “2” and the maximum start accumulation packet number becomes “100”.

After the CPU has set the above-mentioned parameters, control goes to a step S25, whereat the CPU places the RTP reception buffer to the reception start mode and sets a reception interrupt interval, at which the control side of the data decode processing unit 505 shown in FIG. 6 interrupt the CPU, in accordance with the audio data size recognized at the step S23. The reception interrupt interval concerns with interrupt received by the data decode processing unit 505 from the control side. The interrupt at this reception interrupt interval does not occur when the LAN 3 side received audio data.

The telephone terminal 2 or the gateway 4 extracts packets from the RTP reception buffer at this reception intervals and executes the audio transmission processing that will be described later on.

After the CPU has placed the RTP reception buffer in the reception start mode at the step S25, control goes to a step S26, whereat the CPU calculates the magnitude of the delay fluctuation of the packet thus arrived. If the telephone terminal 2 or the gateway 4 has already been placed in the reception start mode as represented by a YES at the decision step S22, then control goes to the step S26, whereat the CPU calculates the magnitude of the delay fluctuation of the arrived packet immediately. The CPU calculates this magnitude of the delay fluctuation at the step S26 on the basis of the aforementioned equation (1).

Then, control goes to a step S27, whereat the CPU calculates the increase target accumulation amount IBᵢ by the aforementioned equations (2) and (3) and also calculates the decrease target accumulation amount DBᵢ by the aforementioned equations (4) and (5) based upon the magnitude of the delay fluctuation.

After the step S27, control goes to a next decision step S28, whereat it is determined by the CPU whether or not the accumulation packet number within the RTP reception buffer is smaller than the initial reproduction packet number.

If the accumulation packet number within the RTP reception buffer is smaller than the initial reproduction packet number as represented by a YES at the decision step S28, then control goes to a step S29, whereat no reproduced packets exist within the RTP reception buffer so that the CPU sets a buffer reference flag, used to read out the packets from the RTP reception buffer, to “FALSE”. Then the CPU inhibits the RTP reception buffer to be referred and instructs that audio data should be reproduced while sounds are not being generated.

Then, control goes to a step S30, whereat the CPU sets the start accumulation amount into the increase target accumulation amount obtained at that time. However, when the increase target accumulation amount is larger than the maximum start accumulation amount (i.e. increase target accumulation amount>maximum start accumulation amount), the start accumulation amount is limited to start accumulation amount maximum start accumulation amount. As mentioned hereinbefore, the initial value of the increase target accumulation amount is the initial value of the start accumulation amount.

At this step S30, when the telephone terminal 2 or the gateway 4 commences to receive the packets, the start accumulation amount is set in such a manner that the buffer size may become equal to the RTP reception buffer size corresponding to the magnitude of the delay fluctuation obtained when the telephone terminal 2 or the gateway 4 received the packets last time.

The fact that the accumulation packet number within the RTP reception buffer is smaller than the initial reproduction packet number means that the packets within the RTP reception buffer are made empty due to the time delay occurred by the delay fluctuation. For this reason, in the state in which the telephone terminal 2 or the gateway 4 has already commenced to receive the packets, at the step S30, the start accumulation amount is increased and changed to the increase target accumulation amount obtained at that time.

Then, control goes to a step S31, whereat the CPU calculates the RTP reception buffer size as:

RTP reception buffer size=start accumulation packet number

At the same time, at a step S32, the CPU calculates the maximum accumulation packet number as:

Maximum accumulation packet number=RTP reception buffer size+overflow buffer discard packet number Next, control goes to a step S33, whereat the CPU sets the retrieval start index at the leading cell of the RTP reception buffer. The retrieval start index is a start index (this index is an index that can indicate a memory cell of the RTP reception buffer) required to retrieve a memory cell of the RTP reception buffer to accumulate a received packet when the next packet is received.

Thereafter, control goes to a step S35, whereat the CPU accumulates received packets in the RTP reception buffer.

If it is determined by the CPU at the decision step S28 that the accumulated packet number is greater than the initial reproduction packet number, then control goes to a step S34, whereat the CPU sets the retrieval start index as:

Retrieval start index=reference index+initial reproduction packet number. Thereafter, control goes to a step S35, whereat the CPU accumulates the received packets in the RTP reception buffer.

In the received packet accumulation processing at the step S35, as mentioned hereinbefore, the CPU retrieves sequence numbers of packets accumulated in the memory cells of the RTP reception buffer in the sequential order of memory cells indicated by the retrieval start index to thereby detect a memory cell in which the packet that is received this time should be stored. Then, the CPU stores the received packet in the memory cell thus detected.

After the received packets had been accumulated in the RTP reception buffer as described above, control goes to a step S41 shown in FIG. 9, whereat the CPU increments the accumulated packet number by one.

Then, control goes to a next decision step S42, whereat it is determined by the CPU based upon the aforementioned judged result of stability of the delay fluctuation whether or not the delay fluctuation is converged. If the delay fluctuation is converged as represented by a YES at the decisions step S42, then control goes to a step S43, whereat the CPU executes the aforementioned decrease procedure of the start accumulation amount. The processing at the step S42 corresponds to the processing at the step S1 shown in FIG. 7 and the processing at the step S43 corresponds to the processing at the steps S2 to S12 shown in FIG. 7.

After the decrease procedure of the start accumulation amount at the step S43 had been ended or if the delay fluctuation is not yet stabilized as represented by a NO at the decision step S42, then control goes to a next decision step S44, whereat it is determined by the CPU whether or not the accumulated packet number in the RTP reception buffer is greater than the maximum accumulated packet number. If the accumulated packet number in the RTP reception buffer is greater than the maximum accumulated packet number as represented by a YES at the decision step S44, then control goes to a step S45. At the step S45, the CPU discards packets of the number corresponding to the overflow buffer discard packet number determined at the step S24 from the leading cell of the RTP reception buffer.

If on the other hand the accumulated packet number is smaller than the maximum accumulated packet number as represented by a NO at the decision step S44 or after the packet discard processing at the step S45 had been ended, then control goes to a next decision step S46, whereat it is determined by the CPU whether or not the accumulated packet number is greater than the buffer size of the RTP reception buffer.

If the accumulated packet number is greater than the buffer size of the RTP reception buffer as represented by a YES at the decision step S46, then control goes to a step S47, whereat the CPU sets the reference index at the cell number of the leading cell of the RTP reception buffer.

Then, control goes to a step S48, whereat the CPU sets the retrieval start index as:

Retrieval start index=reference index+initial reproduction packet number. Thereafter, control goes to a step S49, whereat the CPU sets the buffer reference flag to “TRUE”. Then, at the step S49, CPU also permits the RTP reception buffer to be referred in the audio data transmission processing procedure and instructs the reproduction of audio data to start.

Thereafter, the CPU ends the processing routine required when packets are to be received as described above. Moreover, if the accumulated packet number is not greater than the buffer size of the RTP reception buffer as represented by a NO at the decision step S46, then the CPU ends the processing routine required when packets are to be received as described above.

[Audio Data Transmission Processing]

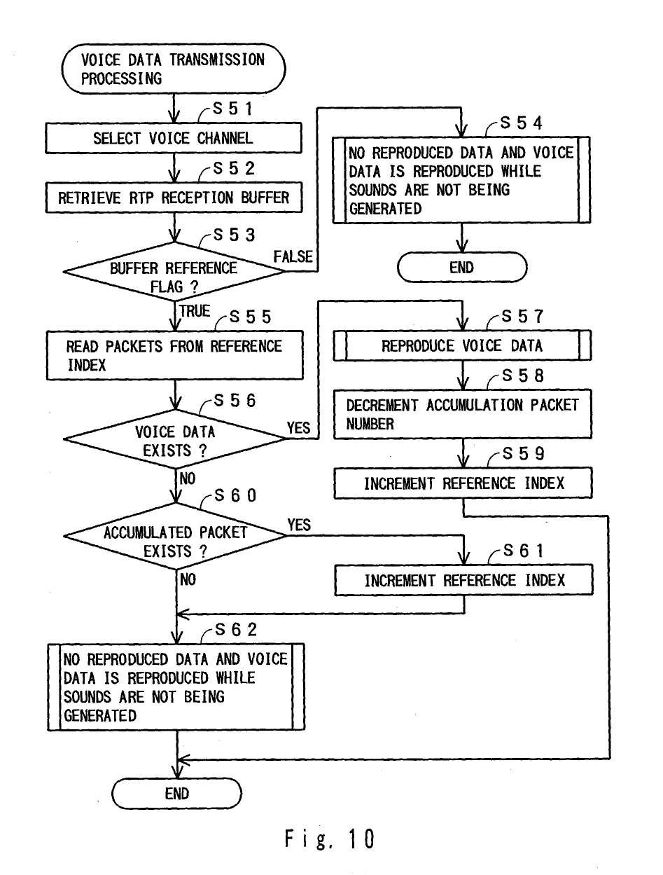

Audio data transmission processing that is to be executed together with the reception processing shown in FIGS. 8 and 9 will be described with reference to a flowchart of FIG. 10. This audio data transmission processing is executed in the case of the gateway 4 and is executed by the data decode processing unit 505 comprising the DSP in the aforementioned functional block diagram of FIG. 6. Processing in the data decode processing unit 505 shown in FIG. 6 is activated by the interrupt interval that has been set as mentioned hereinbefore. As mentioned hereinbefore, according to this embodiment, this interrupt interval is matched with the audio packet size. This interrupt interval, however, may not of course be matched with the audio packet size.

Referring to FIG. 10, in the data decode processing unit 505, first, audio output channel is selected by the CPU at a step S51. A audio channel 1, for example, is set to a ISDN line and a audio channel 2 is set to the analog line. In the case of the telephone terminal 2, this step S51 is not required.

Next, control goes to a step S52, whereat the CPU retrieves the RTP reception buffer. Then, control goes to a next decision step S53, whereat it is determined by the CPU whether the buffer reference flag is “TRUE” or “FLASE”. If it is determined by the CPU that the buffer reference flag is “FALSE”, then control goes to a step S54, whereat it is determined that no audio data that should be reproduced exists and audio data is reproduced while sounds are not being generated.

If it is determined by the CPU that the buffer reference flag is “TRUE”, then control goes to a step S55, whereat packets are read out from the memory cells of the RTP reception buffer. Then, control goes to a next decision step S56, whereat it is determined by the CPU whether or not there is audio data that should be reproduced. If there is audio data that should be reproduced as represented by a YES at the decision step S56, then control goes to a step S57, whereat audio data is reproduced, then control goes to a step S58, wherein the CPU decrements the accumulated packet number of the RTP reception buffer. Then, control goes to a step S59, whereat the CPU increments the reference index, and this audio data transmission processing routine is ended.

If there is no audio data that should be reproduced as represented by a NO at the decision step S56, then control goes to the a decision step S60, whereat it is determined by the CPU whether or not accumulated packets exist within the RTP reception buffer. If accumulated packets exist within the RTP reception buffer as represented by a YES at the decision step S60, then control goes to a step S61, whereat the CPU increments the reference index. Thereafter, control goes to a step S62, whereat it is determined that there exists no audio data that should be reproduced and hence the audio signal is reproduced while sounds are not being reproduced. Then, control is ended. If on the other hand it is determined by the CPU that no accumulated packets exist within the RTP reception buffer as represented by a NO at the decision step S60, then control immediately goes to the step S62, whereat the audio signal is reproduced while sounds are not being generated.

[Specific Examples of Changes Of Packet Number within RTP Reception Buffer]

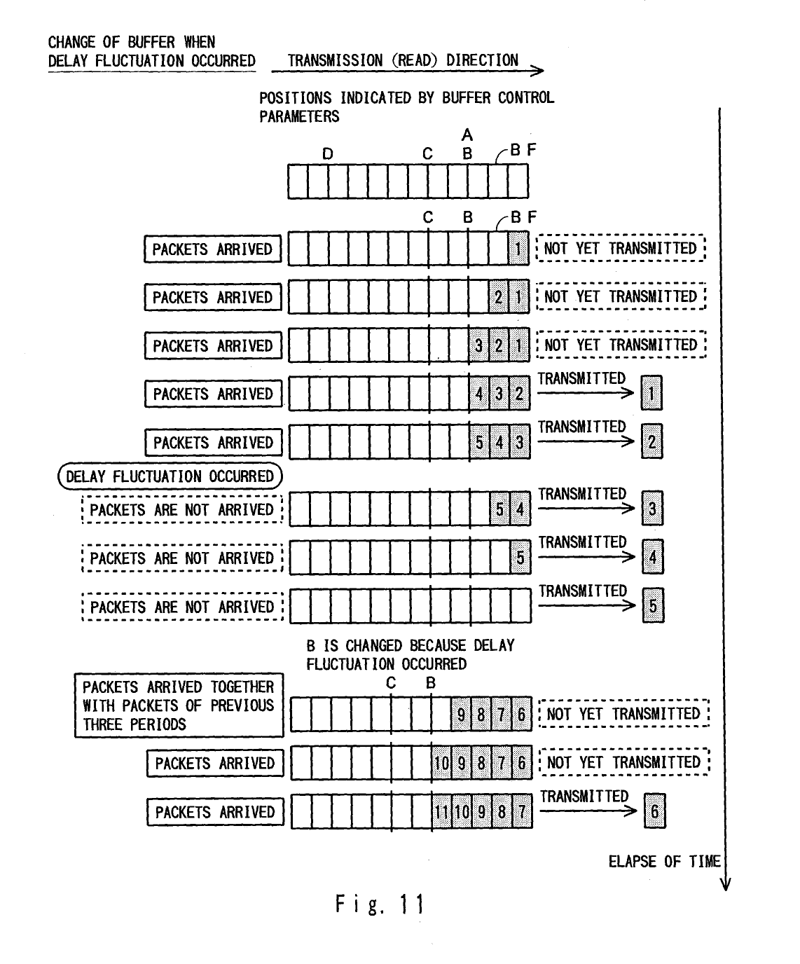

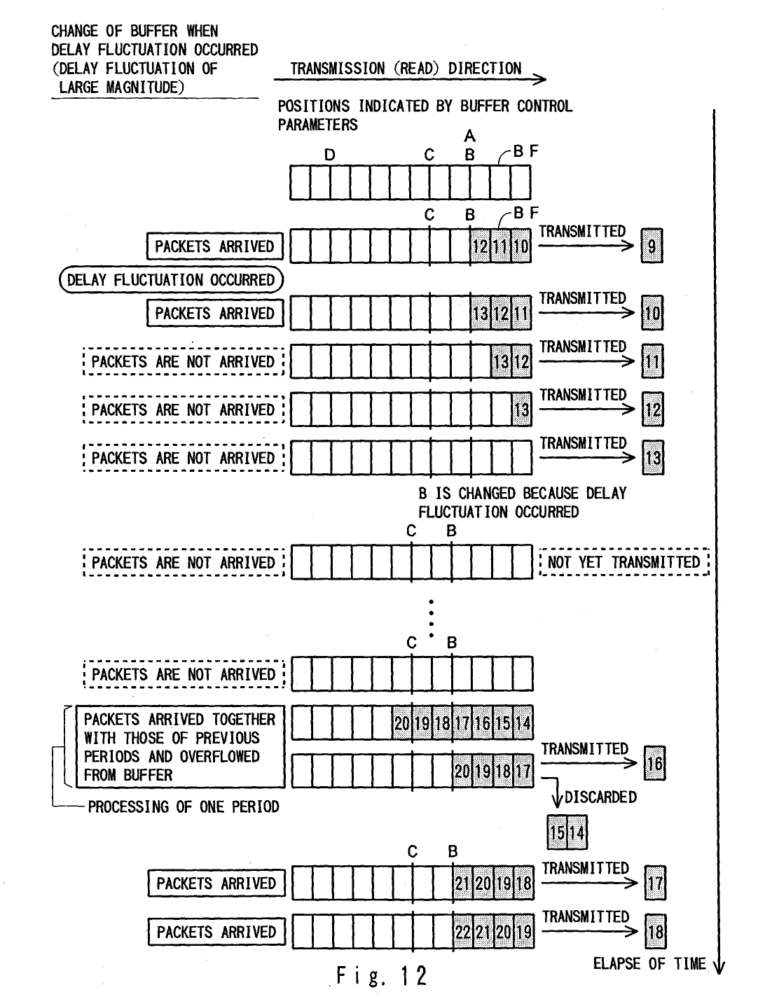

Specific examples of the manner in which the number of packets within the RTP reception buffer is changed when packets are received by the telephone terminal 2 or the gateway 4 will be described with reference to FIGS. 11 to 13. In each of FIGS. 11 to 13, reference letter BF schematically shows the RTP reception buffer.

Memory cells shown by half-tone dot meshing within the RTP reception buffers BF show memory cells in which packets are accumulated. Further, numerals shown in the accumulated packets within the RTP reception buffer denote sequence numbers of the accumulated packets. In other words, in FIGS. 11 to 13, the memory cells shown by half-tone dot meshing show the accumulated packets and the numerals in the portions shown by half-tone dot-meshing denote the sequence numbers of the accumulated packets. In FIGS. 11 to 13, cells at the blank portions show empty cells in which no packets are accumulated.

In the example which will follow, the initial reproduction packet number is set to 1, the initial packet number of the start accumulation amount is set to 3, the initial value of the maximum accumulation packet number is set to 5 and the maximum start accumulation packet number is set to 10. In this case, the start accumulation packet number and the maximum accumulation packet number may be changed dynamically.

In each sheet of the drawings forming FIGS. 11 to 13, reference letters A to D represent respective numbers of packets such that A represents the initial packet number of the start accumulation amount, B represents the start accumulation packet number (dynamically changeable), C represents the maximum accumulation packet number (dynamically changeable) and D represents the maximum start accumulation packet number. Of these numbers A to D shown on each sheet of the drawings forming FIGS. 11 to 13, the positions of B and C represent the initial values of the values of these B and C.

FIG. 11 shows processing executed since the telephone terminal 2 or the gateway 4 has started to receive packets, processing for changing the start accumulation amount and the maximum accumulation packet number because of the occurrence of the delay fluctuation and processing for absorbing delay fluctuation. FIG. 11 shows the case in which the delay fluctuation that occurred is not large enough to discard packets.

As mentioned hereinbefore, when the first packet is received at the telephone terminal 2 or the gateway 4, audio data size (packet size) is recognized, buffer size control parameters are calculated by the CPU of the telephone terminal 2 or the gateway 4 and then the telephone terminal 2 or the gateway 4 is set to the reception start mode. Thereafter, audio data transmission processing, which will be described later on, is executed at the reception interrupt intervals set based upon the audio data size (packet size). Then, the arrived packets are accumulated in the RTP reception buffer BF.

Until three packets are accumulated in the RTP reception buffer since the reception of packets has been started, packets are not read out from the RTP reception buffer BF and audio data is reproduced while sounds are not being generated.

When the fourth packet arrives, the fourth packet is accumulated in the RTP reception buffer. Concurrently therewith, the leading packet is read out from the RTP reception buffer BF at the timing of the aforementioned reception interrupt intervals and audio data is transmitted. Thereafter, packets are sequentially read out from the RTP reception buffer BF at the timing of the reception interrupt intervals and audio data is transmitted. Therefore, so long as the delay fluctuation does not occur, in the example shown in FIG. 11, three packets are constantly accumulated in the RTP reception buffer BF.

When the delay fluctuation occurs, since packets are sequentially read out from the RTP reception buffer BF at the timing of the reception interrupt intervals although the new packet does not arrive next. As a result, so long as the next packet does not arrive, the number of packets accumulated in the RTP reception buffer BF decreases progressively.

Then, when the number of packets accumulated in the RTP reception buffer BF becomes zero, the start accumulation packet number B is changed to the increase target accumulation packet number as mentioned hereinbefore. The maximum accumulation packet number C also is changed in accordance therewith. In the example shown in FIG. 11, the start accumulation packet number is changed to “5” and the maximum accumulation packet number is changed to “7”, respectively.

Thereafter, when four new packets consisting of the next packet and three packets that had been delayed due to the delay fluctuation arrive, these four packets are accumulated in the RTP reception buffer BF. At this time, since the number of the arrived packets does not reach the changed start accumulation packet number “5”, packets are not read out from the RTP reception buffer BF and audio data is reproduced while sounds are not being generated. Then, until the number of packets accumulated in the RTP reception buffer BF reaches “5” by the arrival of new packets, packets are not read out from the RTP reception buffer BF and audio data is reproduced while sounds are not being generated.

Then, when the number of packets accumulated in the RTP reception buffer BF reaches “5”, packets are sequentially read out from the RTP reception buffer BF at the timing of the reception interrupt intervals and audio data is transmitted.

In this manner, since the start accumulation packet number is changed in accordance with the magnitude of occurred delay fluctuation, it is possible to prevent audio data from being reproduced without sounds due to discarded packets.

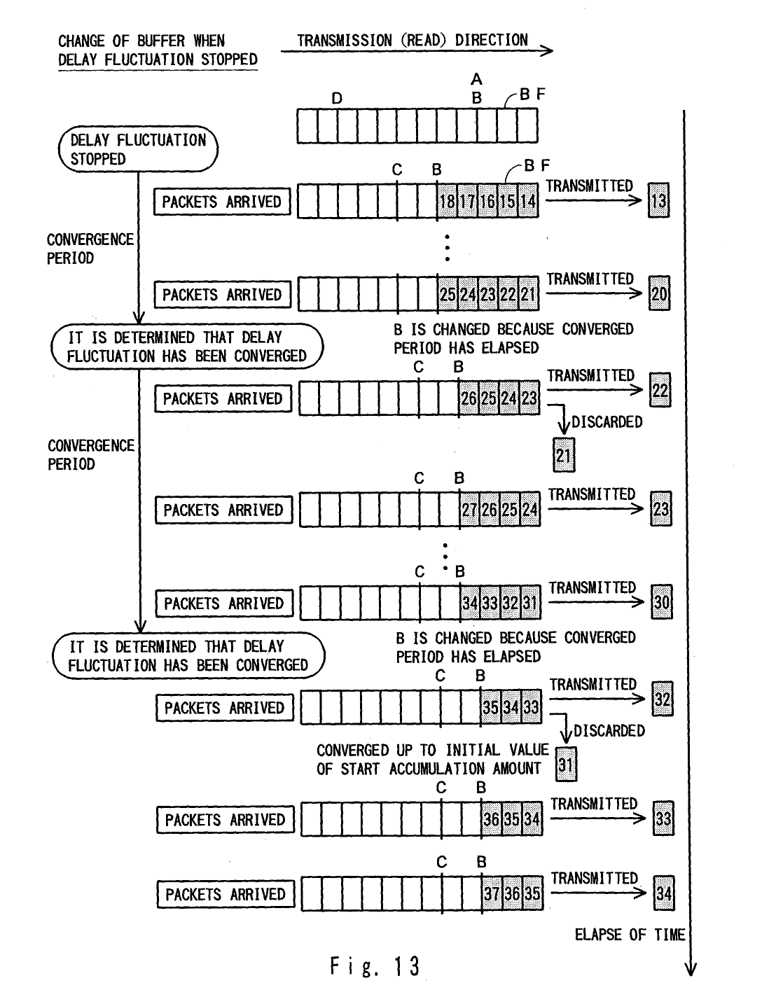

Next, the manner for changing and controlling (increasing and controlling) the buffer size of the RTP reception buffer when the delay fluctuation of a large magnitude occurred will be described with reference to FIG. 12. The example shown in FIG. 12 shows the case in which the delay fluctuation of a large magnitude occurred when the start accumulation packet number is “3” and the maximum accumulation packet number is “5”.

Referring to FIG. 12, until the delay fluctuation occurs, the leading packet of accumulated packets is read out from the RTP reception buffer BF at the timing of the reception interrupt intervals and new received packets are accumulated in the RTP reception buffer BF.

When the delay fluctuation occurs in this state, similarly as described hereinbefore, although a new packet does not arrive, packets are sequentially read out from the RTP reception buffer BF so that the number of packets accumulated in the RTP reception buffer BF decreases progressively.

Then, when the number of packets accumulated in the RTP reception buffer BF reaches zero, similarly as described hereinbefore, the start accumulation packet number B is increased and changed to the increase target accumulation packet number. The maximum accumulation packet number C also is increased and changed in accordance therewith. In the example shown in FIG. 12, the start accumulation packet number is changed to “4” and the maximum accumulation packet number is changed to “6”, respectively.

In the example shown in FIG. 12, since a magnitude of the delay fluctuation is large even after the start accumulation packet number had been increased and changed, it is assumed that arrival of a new packet should be further delayed. Then, it is assumed that new packet that exceeds the maximum accumulation packet number arrive together with a plurality of new packets whose arrivals are delayed should arrive at the same time.

Then, as mentioned hereinbefore, packets whose number corresponds to the overflowed buffer discard packet number being predetermined, in this example, two packets are sequentially discarded from the leading packet in the RTP reception buffer BF. Then, the number of accumulated packets becomes “5” and falls within the maximum accumulation packet number “6”. Then, packets are sequentially read out from the RTP reception buffer BF and reproduced at the reception interrupt intervals.

In the example shown in FIG. 12, since the number of packets accumulated in the RTP reception buffer BF becomes equal to the start accumulation packet number owing to the above-mentioned processing, so long as the delay fluctuation does not occur, thereafter, packets in the leading cell of the RTP reception buffer BF will be sequentially read out from the RTP reception buffer BF and new arrived packets will be accumulated in the RTP reception buffer BF.

Next, the manner in which the buffer size of the RTP reception buffer BF is changed and controlled (increased and controlled) when the delay fluctuation converges progressively will be described with reference to FIG. 13. The example shown in FIG. 13 shows the case in which the delay fluctuation is converging progressively when the start accumulation packet number B increases to “5” so that the maximum accumulation packet number C is “7”.

Specifically, as shown in FIG. 13, during the delay fluctuation is being generated, the start accumulation packet number B is set to “5” and the delay fluctuation absorption processing is executed. As the delay fluctuation is converging, the aforementioned convergence period count value CNT becomes larger than the convergence period constant CNT-th and hence it is determined that the delay fluctuation was stabilized. If it is determined that the delay fluctuation was stabilized, then as mentioned hereinbefore, the start accumulation packet number B is decreased and changed to the decrease target accumulation amount so that packets of the number corresponding to the decreased packets are discarded from the leading packet in the RTP reception buffer BF.

When the delay fluctuation further converges, the convergence period count value CNT becomes again larger than the convergence period constant CNT-th and hence it is determined that the delay fluctuation was stabilized. Then, the start accumulation packet number B is decreased and changed to the decrease target accumulation amount and packets of the number corresponding to the decreased packets are discarded from the leading packet in the RTP reception buffer BF.

After the above-mentioned processing had been repeated, as the delay fluctuation is progressively converging, the start accumulation packet number B is decreased to the initial value.

As described above, according to this embodiment, since the start accumulation packet number of the RTP reception buffer is increased in accordance with the occurrence of the delay fluctuation and the start accumulation packet number is decreased as the delay fluctuation decreases and converges, the buffer size of the RTP reception buffer is dynamically controlled in accordance with the magnitude of the delay fluctuation. Thus, degree in which audio data is reproduced while sounds are not being generated can be alleviated and delay of sounds also can be suppressed to the minimum.

While the start accumulation packet number is changed to the increase target accumulation amount after the RTP reception buffer had been emptied as described above, the present invention is not limited thereto and the following variant is also possible. That is, the start accumulation packet number may be changed to the increase target accumulation amount when the RTP reception buffer is not emptied but the number of packets accumulated in the RTP reception buffer becomes less than a predetermined number, e.g. less than one.

Further, since the present invention can be applied to the delay fluctuation occurred on the LAN when data that should be reproduced in real-time is transmitted through the LAN, it is needless to say that the present invention is not limited to the application to the VoIP telephone system that has been described so far and that the present invention can be applied to a variety of data transmission systems.

Furthermore, data that should be transmitted in real-time to which the present invention is applied is not limited to audio data and may be other suitable data such as video data.

Having described a preferred embodiment of the invention with reference to the accompanying drawings, it is to be understood that the invention is not limited to that precise embodiment and that various changes and modifications could be effected therein by one skilled in the art without departing from the spirit or scope of the invention as defined in the appended claims.

What is claimed is:

1. In a method of controlling a delay fluctuation absorption buffer in which packets in which information that should be reproduced in real-time are packetized at every predetermined time period and transmitted sequentially are received through a delay fluctuation absorption buffer and in which the delay fluctuation occurred in timing at which said packets arrive in a transmission system is controlled by said delay fluctuation absorption buffer, a method of controlling a delay fluctuation absorption buffer comprising the steps of:
starting to read received packets from said delay fluctuation absorption buffer after said received packets of the number corresponding to a start accumulation packet number had been accumulated in said delay fluctuation absorption buffer when said packets start to be received;
discarding said received packets of the predetermined number when the number of said received packets accumulated in said delay fluctuation absorption buffer exceeds a maximum accumulation packet number; and
changing dynamically said start accumulation packet number and said maximum accumulation packet number in response to increase and decrease of magnitude of said delay fluctuation occurred in said transmission system.

2. In a method of controlling a delay fluctuation absorption buffer in which packets in which information that should be reproduced in real-time are packetized at every predetermined time period and transmitted sequentially are received through a delay fluctuation absorption buffer and in which delay fluctuation occurred in timing at which said packets arrive in a transmission system is controlled by said delay fluctuation absorption buffer, a method of controlling a delay fluctuation absorption buffer comprising the steps of:
a process for starting to read received packets from said delay fluctuation absorption buffer after said received packets of the number corresponding to a start accumulation packet number accumulated in said delay fluctuation absorption buffer when said packets start to be received;
a process for discarding said received packets of the predetermined number when the number of said received packets accumulated in said delay fluctuation absorption buffer exceeds a maximum accumulation packet number;
a start accumulation amount increase process for increasing said start accumulation packet number and said maximum accumulation packet number when said delay fluctuation of said received packets larger than a time length corresponding to said start accumulation packet number occurred; and
a start accumulation amount decrease process for changing said start accumulation packet number and said maximum accumulation packet number to smaller values when magnitude of said delay fluctuation is stable at a value smaller than a time length corresponding to said start accumulation packet number set at that time.

3. A method of controlling a delay fluctuation absorption buffer according to claim 2, further comprising a delay fluctuation calculation process for calculating said magnitude of delay fluctuation each time said packet is received and wherein said start accumulation amount increase process includes:
a cumulative calculating process for cumulatively calculating an increase target accumulation amount in which said start accumulation packet number set at that time is set to an initial value based upon said magnitude of delay fluctuation of each said received packet calculated in said delay fluctuation calculation process until the number of packets accumulated in said delay fluctuation absorption buffer becomes less than a previously-determined packet number smaller than said start accumulation packet number set at that time; and
a process for changing said start accumulation packet number to said increase target accumulation amount cumulatively calculated by said cumulative calculating process and stopping reading of packets from said delay fluctuation absorption buffer and re-accumulating said received packets in said delay fluctuation absorption buffer when the number of packets accumulated in said delay fluctuation absorption buffer becomes less than a previously-determined packet number smaller than said start accumulation packet number.

4. A method of controlling a delay fluctuation absorption buffer according to claim 3, wherein said start accumulation packet number is changed to said maximum start packet number instead of said increase target accumulation amount when said increase target accumulation amount is larger than a previously-determined maximum start accumulation packet number.

5. A method of controlling a delay fluctuation absorption buffer according to claim 2, further comprising a delay fluctuation calculation process for calculating magnitude of the delay fluctuation each time said packet is received and said start accumulation amount decrease process includes:
a process for cumulatively calculating a decrease target accumulation amount in which zero is set to an initial value based upon increase and decrease of magnitude of the delay fluctuation of each said received packet calculated by said calculation process; and
a process for changing said start accumulation packet number to said decrease target accumulation amount and discarding extra packets greater than said changed start accumulation packet number accumulated in said delay fluctuation absorption buffer if it is determined that said delay fluctuation is stable and that a value obtained by subtracting said decrease target accumulation amount from said start accumulation packet number set at the time is greater than a previously-set minimum decrease amount.

6. A method of controlling a delay fluctuation absorption buffer according to claim 5, wherein said start accumulation packet number is changed to said maximum decrease amount instead of said decrease target accumulation amount if a value obtained by subtracting said decrease target accumulation amount from said start accumulation packet number set at that time is larger than said minimum decrease amount and which is larger than a previously-determined maximum decrease amount.

7. A method of controlling a delay fluctuation absorption buffer according to claims 1, wherein said information that should be reproduced in real-time is audio information.

8. A method of controlling a delay fluctuation absorption buffer according to claims 2, wherein said information that should be reproduced in real-time is audio information.

9. A method of controlling a delay fluctuation absorption buffer according to claims 1, wherein said transmission system contains an IP (Internet Protocol) network.

10. A method of controlling a delay fluctuation absorption buffer according to claims 2, wherein said transmission system contains an IP (Internet Protocol) network.

11. In an apparatus for controlling a delay fluctuation absorption buffer in which packets in which information that should be reproduced in real-time are packetized at every predetermined time period and transmitted sequentially are received through a delay fluctuation absorption buffer and in which a delay fluctuation occurred in timing at which said packets arrive in a transmission system is controlled by said delay fluctuation absorption buffer, an apparatus for controlling a delay fluctuation absorption buffer comprising:
read start means for starting to read received packets from said delay fluctuation absorption buffer after said received packets of the number corresponding to a start accumulation packet number had been accumulated in said delay fluctuation absorption buffer when said packets start to be received;
received packet discarding means for discarding said received packets of the predetermined number when the number of said received packets accumulated in said delay fluctuation absorption buffer exceeds a maximum accumulation packet number; and
control means for dynamically changing said start accumulation packet number and said maximum accumulation packet number in response to increase and decrease of magnitude of said delay fluctuation occurred in said transmission system.

12. In an apparatus for controlling a delay fluctuation absorption buffer in which packets in which information that should be reproduced in real-time are packetized at every predetermined time period and transmitted sequentially are received through a delay fluctuation absorption buffer and in which a delay fluctuation occurred in timing at which said packets arrive in a transmission system is controlled by said delay fluctuation absorption buffer, an apparatus for controlling a delay fluctuation absorption buffer comprising:
read start means for starting to read received packets from said delay fluctuation absorption buffer after said received packets of the number corresponding to a start accumulation packet number had been accumulated in said delay fluctuation absorption buffer when said packets start to be received;
received packet discarding means for discarding said received packets of the predetermined number when the number of said received packets accumulated in said delay fluctuation absorption buffer exceeds a maximum accumulation packet number;
delay fluctuation calculating means for calculating magnitude of said delay fluctuation each time said packet is received;
cumulative calculating means for cumulatively calculating an increase accumulation target amount in which said said start accumulation packet number is set to an initial value based upon increase and decrease of magnitude of said delay fluctuation of each said received packet calculated by said delay fluctuation calculating means until the number of packets accumulated in said delay fluctuation absorption buffer becomes less than a previously-determined packet number smaller than said start accumulation packet number; and
control means for changing said start accumulation packet number to said increase target accumulation amount cumulatively calculated by said cumulative calculating means, stopping reading of packets from said delay fluctuation absorption buffer and re-accumulating received packets in said delay fluctuation absorption buffer when the number of packets accumulated in said delay fluctuation absorption buffer becomes less than a previously-determined packet number smaller than said start accumulation packet number.

13. An apparatus for controlling a delay fluctuation absorption buffer according to claim 12, wherein said cumulative calculating means changes said start accumulation packet number to said maximum start packet number instead of said increase target accumulation amount if said increase target accumulation amount is greater than a previously-determined maximum start accumulation packet number.

14. An apparatus for controlling a delay fluctuation absorption buffer according to claim 12, further comprising:
means for cumulatively calculating a decrease target accumulation amount in which zero is set to an initial value based upon increase and decrease of magnitude of said delay fluctuation of each said received packet calculated by said delay fluctuation calculating means; and
means for changing said start accumulation packet number to said decrease target accumulation amount and discarding extra packets of the number greater than said changed start accumulation packet number stored in said delay fluctuation absorption buffer if it is determined that magnitude of said delay fluctuation is stable at a value smaller than a time length corresponding to said start accumulation packet number and if a value obtained by subtracting said decrease target accumulation amount from said start accumulation packet number is greater than a previously-set minimum decrease amount.

15. An apparatus for controlling a delay fluctuation absorption buffer according to claim 14, further comprising means for changing said start accumulation packet number to said maximum decrease amount instead of said decrease target accumulation amount if a value obtained by subtracting said decrease target accumulation amount from said start accumulation packet number obtained at that time is greater than said minimum decrease amount and if said value is greater than a previously-determined maximum decrease amount.

16. An apparatus for controlling a delay fluctuation absorption buffer according to any one of claims 11, wherein said information that should be reproduced in real-time is audio information.

17. An apparatus for controlling a delay fluctuation absorption buffer according to claims 12, wherein said information that should be reproduced in real-time is audio information.

18. An apparatus for controlling a delay fluctuation absorption buffer according to claims 11, wherein said transmission system contains an IP (Internet Protocol) network.

19. An apparatus for controlling a delay fluctuation absorption buffer according to claims 12, wherein said transmission system contains an IP (Internet Protocol) network.
